(19) United States
(12) Patent Application Publication
(10) Pub. No.: US 2024/0070065 A1
(43) Pub. Date: Feb. 29, 2024

(54) METHOD TO OFFLOAD MEMORY TIERING FROM THE CPU TO THE MEMORY DEVICE

(71) Applicant: Dell Products L.P., Round Rock, TX (US)

(72) Inventors: Quy Ngoc Hoang, Round Rock, TX (US); Stuart Allen Berke, Austin, TX (US)

(21) Appl. No.: 17/899,245

(22) Filed: Aug. 30, 2022

(51) Int. Cl. G06F 12/02

(52) U.S. Cl. CPC G06F 12/0292; G06F 2212/1024

(57) ABSTRACT

An information handling system includes a memory controller coupled to a first memory device and to a second memory device. The first and second memory devices are configured to receive memory access requests addressed based upon a device physical address (DPA) space of the memory controller. The memory controller incudes a page redirection table having an entry for each page of a host physical address (HPA) space of the information handling system corresponding with the pages of the DPA space. Each entry of the page redirection table associates the particular page of the HPA space with a page within the DPA space. The memory controller receives memory access requests addressed with HPAs from a host processor, and fulfills the memory access requests from a selected one of the first and second memory devices based upon DPAs determined from the entries of the page redirection table.

### FIELD OF THE DISCLOSURE

This disclosure generally relates to information handling systems, and more particularly relates to offloading memory tiering from a CPU of an information handling system to a memory device of the information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include multiple memory devices configured to receive memory access requests addressed based upon a device physical address (DPA) space of a memory controller. The memory controller may include a page redirection table having an entry for each page of a host physical address (HPA) space of the information handling system corresponding with the pages of the DPA space. Each entry of the page redirection table may associate the particular page of the HPA space with a page within the DPA space. The memory controller may receive memory access requests addressed with HPAs from a host processor, and may fulfill the memory access requests from a selected one of a first and a second memory devices based upon DPAs determined from the entries of the page redirection table.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a compute express link (CXL) information handling system according to an embodiment of the current disclosure;

FIGS. 2A-C include block diagrams of an information handling system and illustrate a method for providing memory tiering as is known in the art;

FIGS. 3A-C include block diagrams of an information handling system and illustrate a method for providing memory tiering according to an embodiment of the current disclosure; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

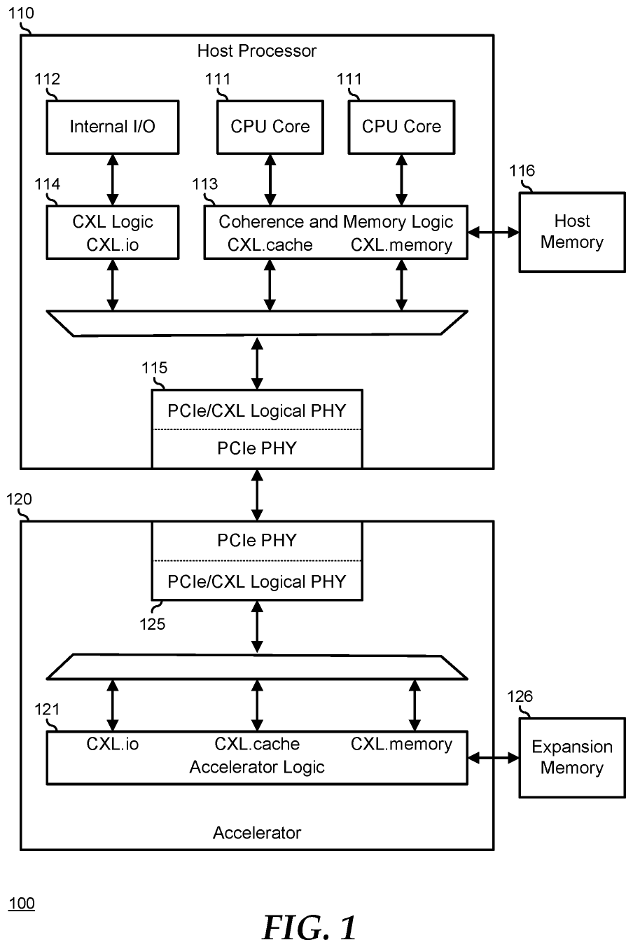

FIG. 1 shows an information handling system 100, including a host processor 110 with associated host memory 116, and an accelerator device 120 with associated expansion memory 126. Host processor 110 includes one or more processor core 111, various internal input/output (I/O) devices 112, coherence and memory logic 113, compute express link (CXL) logic 114, and a PCIe physical layer (PHY) interface 115. Coherence and memory logic 113 provides cache coherent access to host memory 116. The operation of a host processor, and particularly of the component functional blocks within a host processor, are known in the art, and will not be further described herein, except as needed to illustrate the current embodiments.

Accelerator device 120 includes accelerator logic 121, and a PCIe PHY interface 125 that is connected to PCIe PHY interface 115. Accelerator logic 121 provides access to expansion memory 126. Accelerator device 120 represents a hardware device configured to enhance the overall performance of information handling system 100. Examples of accelerator device 120 may include a smart network interface card (NIC) or host bus adapter (HBA), a graphics processing unit (GPU), field programmable gate array (FPGA), or application specific integrated circuit (ASIC) device, a memory management and expansion device or the like, or another type of device configured to improve the performance of information handling system 100, as needed or desired. In particular, being coupled to host processor 110 via the PCIe link established between PCIe interfaces 115 and 125, accelerator device 120 may represent a task-based device that receives setup instructions from the host processor, and then independently executes the tasks specified by the setup instructions. In such cases, accelerator device 120 may access host memory 116 via a direct memory access (DMA) device or DMA function instantiated on the host processor. When representing a memory management device, accelerator device 120 may represent a device configured to provide an expanded memory capacity, in the form of expansion memory 126, thereby increasing the overall storage capacity of information handling system 100, or may represent a memory capacity configured to increase the memory bandwidth of the information handling system, as needed or desired.

Information handling system 100 represents an information handling system configured in conformance with a CXL standard, such as a CXL 1.1 specification, a CXL 2.0 specification, or any other CXL standard as may be published from time to time by the CXL Consortium. The CXL standard is an industry-supported interconnection standard that provides a cache-coherent interconnection between processors, accelerator devices, memory expansion devices, or other devices, as needed or desired. In this way, operations performed at diverse locations and by diverse architectures may maintain a memory coherency domain across the entire platform. The CXL standard provides for three (3) related protocols: CXL.io, CXL.cache, and CXL.memory. The CXL.io protocol represents an I/O protocol that is based upon the PCIe 5.0 protocol (for CXL specification 1.1) or the PCIe 6.0 protocol (for CXL specification 2.0).

For example, the CXL.io protocol provides for device discovery, configuration, and initialization, interrupt and DMA handling, and I/O virtualization functions, as needed or desired. The CXL.cache protocol provides for processors to maintain a cache-coherency domain with accelerator devices and their attached expansion memory, and with capacity- and bandwidth-based memory expansion devices, as needed or desired. The CXL.memory protocol permits processors and the like to access memory expansion devices in a cache-coherency domain utilizing load/store-based commands, as needed or desired. Further, the CXL.memory protocol permits the use of a wider array of memory types than may be supported by processor 110. For example, a processor may not provide native support for various types of non-volatile memory devices, such as Intel Optane Persistent Memory, but the targeted installation of an accelerator device that supports Intel Optane Persistent Memory may permit the information handling system to utilize such memory devices, as needed or desired.

In this regard, host processor 110 and accelerator device 120 each include logic and firmware configured to instantiate the CXL.io, CXL.cache, and CXL.memory protocols. In particular, within host processor 110, coherence and memory logic 113 instantiates the functions and features of the CXL.cache and CXL.memory protocols, and CXL logic 114 implements the functions and features of the CXL.io protocol. Further, PCIe PHY 115 instantiates a virtual CXL logical PHY. Likewise, within accelerator device 120, accelerator logic 121 instantiates the CXL.io, CXL.cache, and CXL.memory protocols, and PCIe PHY 125 instantiates a virtual CXL logical PHY. Within a CXL enabled accelerator device such as accelerator device 120, both the CXL.cache and CXL.memory protocols do not have to be instantiated, as needed or desired, but any CXL enabled accelerator device must instantiate the CXL.io protocol.

In a particular embodiment, the CXL standard provides for the initialization of information handling system 100 with a heavy reliance on existing PCIe device and link initialization processes. In particular, when information handling system 100 is powered on, the PCIe device enumeration process operates to identify accelerator 120 as a CXL device, and that the operations of the accelerator, in addition to providing for standard PCIe operation, functions, and features, may be understood to provide for additional CXL operation, functions, and features. For example, accelerator 120 enables CXL features such as global memory flush, CXL reliability, availability, and serviceability (RAS) features, CXL metadata support, and the like. In addition to the enablement of the various CXL operation, functions, and features, accelerator 120 will be understood to enable operations at higher interface signaling rates, such as 16 giga-transfers per second (GT/s) or 32 GT/s.

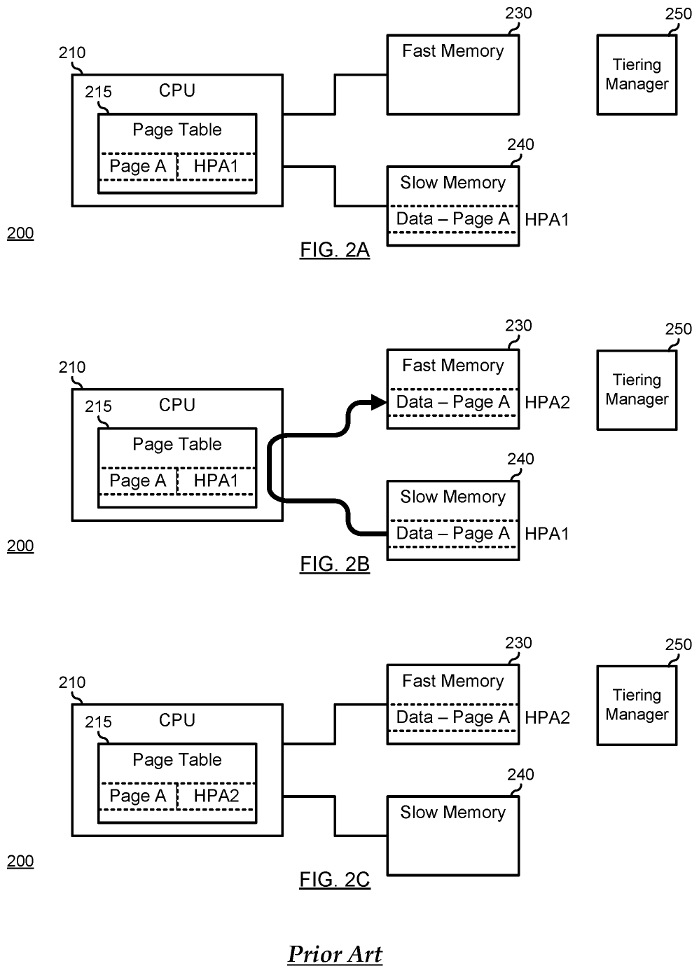

FIGS. 2A-C illustrate an information handling system 200 and a method for providing memory tiering as is known in the art. Information handling system 200 includes a central processing unit (CPU) 210, a fast memory device 230, a slow memory device 240, and a tiering manager 250. Information handling system 200 is configured to provide data storage in a tiered memory architecture where more commonly utilized data is stored in memory tiers that provide CPU 210 with faster access to the data, such as fast memory device 230, and where less commonly utilized data is stored in memory tiers that provide the CPU with slower access to the data, such as slow memory device 240. Typically, fast memory device 230 represents a memory device that trades capacity for low-latency access times, while slow memory device 240 represents a memory device that trades access times for high data storage capacity. Tiering manager 250 monitors the access rates for particular pages of memory stored on the memory tiers.

When a particular page of data is determined to be more commonly accessed, tiering manager 250 operates to move the particular page of data up from lower, slower, tiers to higher, faster, tiers. Tiering manager 250 may also operate to evict less commonly accessed pages of data from the faster tiers to make room for the more commonly accessed pages of data, as needed or desired. Similarly, when a particular page of data is determined to be less commonly accessed, the tiering manager operates to move the particular page of data down to lower, slower, tiers from higher, faster, tiers. Tiering manager 250, as described herein, may be implemented in whole or in part in hardware, in firmware, such as a in a basic input/output system/universal extensible firmware interface (BIOS/UEFI) instantiated on information handling system 200, in an operating system (OS) instantiated on the information handling system, or in a application or program launched by the OS, as needed or desired.

FIG. 2A illustrates an initial case where a particular page of data (Page A) is stored in the host physical address (HPA) space at a particular address (HPA1) within slow memory device 240. CPU 210 includes a page table 215 that maps the page of data (Page A) to the particular address (HPA1). It is assumed that tiering manager 250 has monitored the accesses to the page of data (Page A) and determined that the page of data (Page A) should be moved from slow memory device 240 to fast memory device 230. For example, the number of accesses to the page of data (Page A) has exceeded a particular rate, or tiering manager 250 may have otherwise determined that the page of data (Page A) should be moved from the slow memory device to the fast memory device. Tiering manager 250 operates to initiate a move of the page of memory (Page A) from slow memory device 240 to fast memory device 230. The process of determining the movement of pages of data within a tiered memory architecture is known in the art and will not be further described herein, except as may be needed to illustrate the current embodiment. However, the decision by tiering manager 250 to move data within a tiered memory architecture will typically involve the execution of code by CPU 210.

FIG. 2B illustrates a first step in the process of moving the page of data (Page A) from slow memory device 240 to fast memory device 230. Tiering manager 250 initiates a transfer of the page of data (Page A) from the particular address (HPA1) in slow memory device 240 to a new address (HPA2) in fast memory device 230. In a particular case, tiering manager 250 may initiate code on CPU 210 to successively read lines of the page of data (Page A) from slow memory device 240, in a format suited to the slow memory device, and to write the lines of the page of data (Page A) to fast memory device 230, in a format suited to the fast memory device. For example, slow memory device 240 may represent a block-accessible data storage device such as a solid-state drive (SSD), or the like, and fast memory device 230 may represent an address-accessible data storage device such as a Dual In-Line Memory Module (DIMM).

The data access sizes for slow memory device 240 and fast memory device 230 may not be the same, and so, the transfer of the page of data (Page A) from the initial address (HPA1) to the new address (HPA2) may include one or more steps of storing data within a buffer to match data access sizes between slow memory device 240 and fast memory device 230, as needed or desired. In another case, the process of moving the page of data (Page A) from the initial address (HPA1) to the new address (HPA2) may include commanding a direct memory access (DMA) device to perform the movement of the data. The movement of data from one memory address to another memory address is known in the art and will not be further described herein, except as may be needed to illustrate the current embodiments. However, the movement of data within a tiered memory architecture will typically involve the execution of additional code by CPU 210.

FIG. 2C illustrates a third step in the process of moving the page of data (Page A) from slow memory device 240 to fast memory device 230. Tiering manager 250 has completed the transfer of the page of data (Page A) from the initial address (HPA1) to the new address (HPA2). Then tiering manager 250 operates to modify the contents of page table 215 to map the page of data (Page A) to the new address (HPA2), thereby completing the transfer of the page of data (Page A). Normal processing by CPU 210 then continues with access requests to the page of data (Page A) mapped to the new address (HPA2). The modification of page table contents to reflect moved pages of data is known in the art and will not be further described herein, except as may be needed to illustrate the current embodiments. However, the modification of page table contents will typically involve the execution of additional code by CPU 210.

The tiering process steps as described with regard to FIGS. 2A-C may be performed separately, or may be performed simultaneously, as needed or desired, and may be performed in any order as needed or desired. It will be understood that it may be necessary, during one or more step of the tiering process, that memory transactions on one or more memory interface between CPU 210 and fast memory device 230, and between the CPU and slow memory device 240, may need to be halted for other processes on the CPU while the transfer is occurring. As such, tiering process will consume a large quantity of the processing resources of CPU 210 while the process is ongoing. A similar tiering process for moving less frequently utilized pages of data from fast memory device 230 to slow memory device 240 may proceed similarly to the illustrated tiering process, as needed or desired.

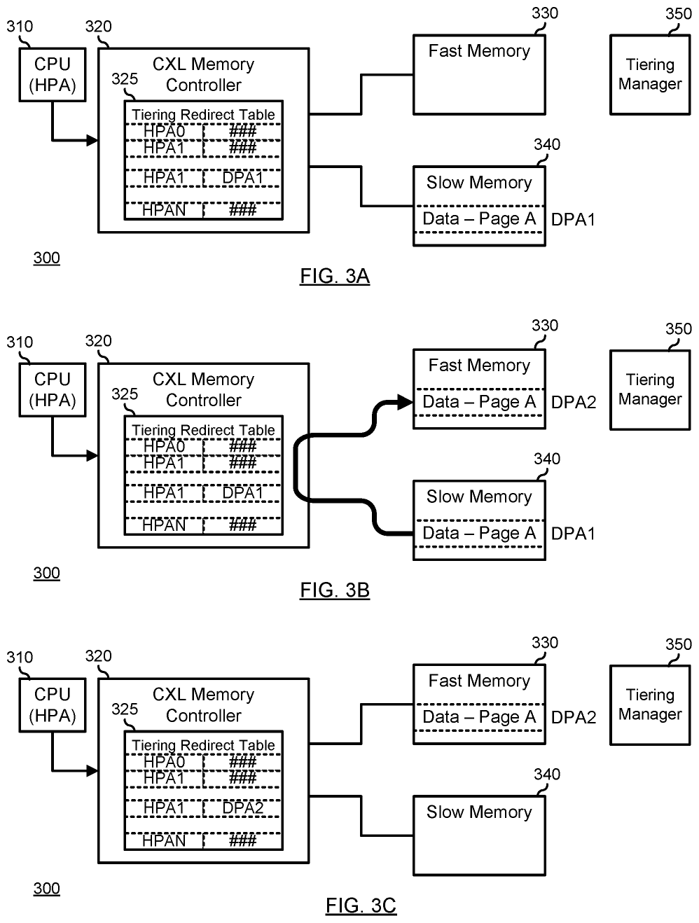

FIGS. 3A-C illustrate an information handling system 300 and a method for providing memory tiering according to an embodiment of the current disclosure. Information handling system 300 includes a central processing unit (CPU) 310, a CXL memory controller 320, a fast memory device 330, a slow memory device 340, and a tiering manager 350. Information handling system 300 is similar to information handling system 200, and is configured to provide data storage in a tiered memory architecture with fast memory device 330 slow memory device 340. Tiering manager 350 monitors the access rates for particular pages of memory stored on the memory tiers. Then, when a particular page of data is determined to be more commonly accessed, tiering manager 350 operates to move the particular page of data up from lower, slower, tiers to higher, faster, tiers. Tiering manager 350 may also operate to evict less commonly accessed pages of data from the faster tiers to make room for the more commonly accessed pages of data, as needed or desired. Similarly, when a particular page of data is determined to be less commonly accessed, tiering manager 350 operates to move the particular page of data down to lower, slower, tiers from higher, faster, tiers.

In a particular embodiment, tiering manager 350 is instantiated on, or incorporated into CXL memory controller 320, as needed or desired. CXL memory module 320, in its capacity as providing tiering manager 350, operates to determine when a particular page of data is more or less commonly accessed, and further, to perform the actual movement of the page of data and the remapping, as described below. In another embodiment, tiering manager 350 is instantiated in the host environment provided by CPU 310, such as in a BIOS/UEFI instantiated on information handling system 300, in an operating system (OS) instantiated on the information handling system, or in a application or program launched by the OS, as needed or desired. Tiering manager 350 operates in its capacity to determine when a particular page of data is more or less commonly accessed, but then the tiering manager operates to offload the movement and mapping of the page of data to CXL memory controller 320, as described below. In this embodiment, only the processing overhead of the tiering process that involves the determination to move pages of data remains associated with CPU 310, but the bulk of the processing of the tiering process that involves the actual movement of the page of data, and the remapping is performed by CXL memory controller 320, as described below.

FIG. 3A illustrates an initial case where a particular page of data (Page A) is stored in a device physical address (DPA) space at a particular address (DPA1) within slow memory device 340. CPU 310 access data within the DPA space controlled by CXL memory controller 320 by sending associated HPA addresses to the CXL memory controller. In a particular embodiment, CXL memory controller 320 includes a page tiering redirection table 325 that includes an entry for every page of the HPA space that is assigned to the CXL memory controller. For example, where CXL memory controller 320 is assigned an address range within the HPA space of 256 GigaBytes (GB), and the HPA space is addressed utilizing 4 KiloByte (KB) pages, then page tiering redirection table 325 will include (2²⁸)/(2¹²)=64 K (65,536) HPA space entries. Each entry in page tiering redirection table 325 will provide DPA address bits [n:12], where n is dependent upon the memory media capacity on the various memory devices controlled by CXL memory controller 320.

Page tiering redirection table 325 then operates to receive memory transactions with the various HPA addresses, and to map the memory transactions to various addresses within the DPA space of controlled by CXL memory controller 320. Thus when CPU 310 provides a memory transaction addressed to HPA1, page tiering redirection table 325 operates to redirect the memory transaction to the page of data (Page A) at the address (DPA1) in slow memory device 340. In another embodiment, page tiering redirection table 325 includes an entry for every page of the entire HPA space. Each of fast memory device 330 and slow memory device 340 may have their own DPA space, and the entries in page tiering redirection table 325 will include addressing to direct memory access requests to the correct one of the memory devices. CXL memory controller 320 will be understood to provide tiering management for the entirety of the HPA space, as needed or desired.

In FIG. 3A, it is further assumed that tiering manager 350 has monitored the accesses to the page of data (Page A) and determined that the page of data (Page A) should be moved from slow memory device 340 to fast memory device 330. For example, the number of accesses to the page of data (Page A) has exceeded a particular rate, or tiering manager 350 may have otherwise determined that the page of data (Page A) should be moved from the slow memory device to the fast memory device. Tiering manager 350 operates to initiate a move of the page of memory (Page A) from slow memory device 340 to fast memory device 330. As noted above, the process of determining the movement of pages of data within a tiered memory architecture may be provided within a hosted environment, or may be provided by CXL memory controller 320, as needed or desired. However the decision by a tiering manager to move data within a tiered memory architecture may or may not involve the execution of code by CPU 310, depending upon the particular embodiment, as described above.

FIG. 3B illustrates a first step in the process of moving the page of data (Page A) from slow memory device 340 to fast memory device 330. Tiering manager 350 initiates a transfer of the page of data (Page A) from the particular address (DPA1) in slow memory device 340 to a new address (DPA2) in fast memory device 330. In a particular embodiment, CXL memory controller 320 operates to successively read lines of the page of data (Page A) from slow memory device 340, in a format suited to the slow memory device, and to write the lines of the page of data (Page A) to fast memory device 330, in a format suited to the fast memory device. The data access sizes for slow memory device 340 and fast memory device 330 may not be the same, and so, the transfer of the page of data (Page A) from the initial address (DPA1) to the new address (DPA2) may include one or more steps of storing data within a buffer to match data access sizes between slow memory device 340 and fast memory device 330, as needed or desired. In another embodiment, the process of moving the page of data (Page A) from the initial address (DPA1) to the new address (DPA2) may include commanding a direct memory access (DMA) device to perform the movement of the data. The movement of data within the tiered memory architecture controlled by CXL memory controller 320 will be performed by the CXL memory controller without necessitating any additional code execution by CPU 310.

FIG. 3C illustrates a third step in the process of moving the page of data (Page A) from slow memory device 340 to fast memory device 330. Tiering manager 350 has completed the transfer of the page of data (Page A) from the initial address (DPA1) to the new address (DPA2). Then tiering manager 350 operates to modify the contents of page tiering redirection table 325 to map the page of data (Page A) to the new address (DPA2), thereby completing the transfer of the page of data (Page A). Processing by CPU 310 then continues with access requests to the page of data (Page A), as accessed by the address within the HPA space (HPA1) mapped by page tiering redirection table 325 to the new address (DPA2). Here, it will be further understood that the remapping of the host address (HPA1) from the initial DPA address (DPA1) to the new DPA address (DPA2) will be performed by the CXL memory controller without necessitating any additional code execution by CPU 310.

The tiering process steps as described with regard to FIGS. 3A-C may be performed separately, or may be performed simultaneously, as needed or desired, and may be performed in any order as needed or desired. It may be necessary, during one or more steps of the tiering process, to halt or slow memory transactions on one or more memory interfaces between CXL memory controller 320 and fast memory device 330, and between the CXL memory controller and slow memory device 340. However, other transactions from CPU 310 may not need to be halted or slowed while the tiering process is being performed. As such, tiering process described with regard to FIGS. 3A-C will not consume as much of the processing resources of CPU 310 while the tiering process is ongoing. A similar tiering process for moving less frequently utilized pages of data from fast memory device 330 to slow memory device 340 may proceed similarly to the illustrated tiering process, as needed or desired.

In a particular embodiment, each entry in page tiering redirection table 325 further includes one or more control bits that is used by CXL memory controller 320 to manage the tiering process. For example, each entry in page tiering redirection table 325 may include status information (such as Valid, Modified, Shared, etc.), Host ID(s), an access counter, Shared, any host requested tier level information, or the like. In a particular embodiment, an information handling system similar to information handling system 300 includes a memory topology with multiple memory levels, such as where a processor is connected to a CXL switch that directly connects via one or more downstream lane to a memory storage device, and via one or more other downstream lanes to additional CXL switches and other memory storage devices. In a particular case, a memory controller at each layer of the memory topology may include a page tiering redirection table for the management of the data stored thereunder. In this way, each layer may operate as a sub-tiering group and can manage the tiering operations of the data stored thereunder. Further, a top level memory controller may include an extended page tiering redirection table that tracks the movement of data across the various levels of the memory topology, as needed or desired. As described, the memory page size is described as being a 4K memory page size, but the page size may be larger or smaller than 4K, as needed or desired.

In a particular embodiment, a host CPU implements mechanisms that permit the BIOS/UEFI, the OS, or applications to provide tiering hints to the CXL memory controller, as needed or desired. In another embodiment, such mechanisms may be monitored, managed, and maintained by an out-of-band processing environment, such as may be established by a baseboard management controller (BMC), or the like. In a particular embodiment, the CXL memory controller can provide status information the host CPU or out-of-band device as to the current mapping of the page tiering redirection table, as needed or desired, for example for memory usage logging, or the like. In a particular embodiment, a CXL memory controller may implement additional hardware such as translation lookaside buffers (TLBs) to accelerate HPA to DPA mapping, as needed or desired.

While the functions and features of information handling system 300 in general, and particularly of CXL memory controller 320 were described in the context of a tiered memory topology, the functions and features of the information handling system and the CXL memory controller may be utilized in other capacities, as needed or desired. For example, the movement of pages of data from one memory device to another memory device without necessitating remapping of page tables in a processor of the information handling system may be utilized in other operations, such as hot-swapping of memory devices in a particular memory socket. The data in the memory device to be swapped out can remain accessible to the processor during the hot-swap process, as needed or desired. In other examples, the movement of pages of data from one memory device to another memory device without necessitating remapping of page tables may be utilized to replace a memory device that is predicted to fail, to take a memory device off line for servicing (i.e., providing a firmware update or the like), to consolidate data to fewer memory devices (i.e., to conserve power or the like), to move data to a different memory device that provides memory persistence or other differentiating characteristics, or other reasons as needed or desired.

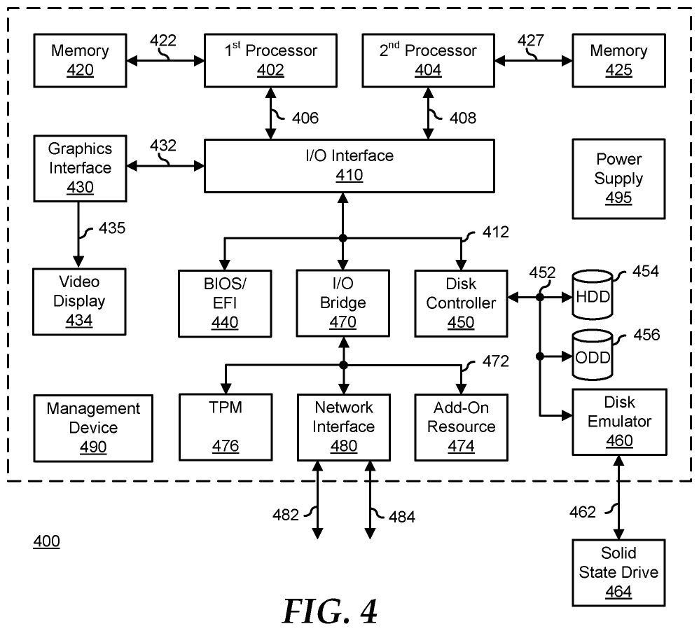

FIG. 4 illustrates a generalized embodiment of an information handling system 400. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below, and operates to perform one or more of the methods described below. Information handling system 400 includes processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420 and 425, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432, and provides a video display output 435 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412, or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400. Management device 490 can operate off of a separate power plane from the components of the host environment so that the management device receives power to manage information handling system 400 when the information handling system is otherwise shut down. An example of management device 490 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a first memory device;
a second memory device; and
a memory controller coupled to the first memory device and to the second memory device;
wherein:
the first memory device and the second memory device are each configured to receive memory access requests addressed based upon a device physical address (DPA) space of the memory controller;
the memory controller incudes a page redirection table having an entry for each page of a host physical address (HPA) space of the information handling system corresponding with the pages of the DPA space, each entry of the page redirection table associating the particular page of the HPA space with a page within the DPA space; and
the memory controller is configured to receive memory access requests from a host processor, the memory access requests being addressed with HPAs, and to fulfill the memory access requests from selected ones of the first memory device and the second memory device based upon DPAs determined from the entries of the page redirection table associated with the HPAs.

2. The information handling system of claim 1, wherein the memory controller is further configured to receive an indication that a first page of data at a first DPA in the first memory device is to be moved to the second memory device, wherein the first DPA is associated with a first HPA in a first entry of the page redirection table.

3. The information handling system of claim 2, wherein, in response to receiving the indication, the memory controller is further configured to move the first page of data from the first memory device to a second DPA in the second memory device, and to change the first entry of the page redirection table to associate the first HPA with the second DPA.

4. The information handling system of claim 3, wherein the first memory device and the second memory device comprise a tiered memory topology for the information handling system.

5. The information handling system of claim 4, wherein the first memory device is in a slow memory tier of the tiered memory topology, and the second memory device is in a fast memory tier of the tiered memory topology.

6. The information handling system of claim 3, further comprising:
a processor configured to instantiate a memory tiering management module that provides the indication.

7. The information handling system of claim 3, wherein the memory controller includes a memory tiering management module that provides the indication.

8. The information handling system of claim 2, wherein the indication is in response to a hot-swap request to swap the first memory device.

9. The information handling system of claim 1, wherein the memory controller is a compute express link memory controller.

10. A method, comprising:
coupling a memory controller of an information handling system to a first memory device and second memory device, wherein the first memory device and the second memory device are each configured to receive memory access requests addressed based upon a device physical address (DPA) space of the memory controller;
providing, in the memory controller, a page redirection table having an entry for each page of a host physical address (HPA) space of the information handling system corresponding with the pages of the DPA space, each entry of the page redirection table associating the particular page of the HPA space with a page within the DPA space;
receiving, by the memory controller, memory access requests from a host processor, the memory access requests being addressed with HPAs; and
fulfilling the memory access requests from selected ones of the first memory device and the second memory device based upon DPAs determined from the entries of the page redirection table associated with the HPAs.

11. The method of claim 10, further comprising receiving an indication that a first page of data at a first DPA in the first memory device is to be moved to the second memory device, wherein the first DPA is associated with a first HPA in a first entry of the page redirection table.

12. The method of claim 11, wherein, in response to receiving the indication, the method further comprises:
moving the first page of data from the first memory device to a second DPA in the second memory device; and
changing the first entry of the page redirection table to associate the first HPA with the second DPA.

13. The method of claim 12, wherein the first memory device and the second memory device comprise a tiered memory topology for the information handling system.

14. The method of claim 13, wherein the first memory device is in a slow memory tier of the tiered memory topology, and the second memory device is in a fast memory tier of the tiered memory topology.

15. The method of claim 12, further comprising instantiating, by a processor of the information handling system, a memory tiering management module that provides the indication.

16. The method of claim 12, wherein the memory controller includes a memory tiering management module that provides the indication.

17. The method of claim 11, wherein the indication is in response to a hot-swap request to swap the first memory device.

18. The method of claim 10, wherein the memory controller is a Compute Express Link memory controller.

19. A memory controller coupled to a first memory device and to a second memory device, the first memory device and the second memory device each configured to receive memory access requests addressed based upon a device physical address (DPA) space of the memory controller, the memory controller comprising:
a tiering manager; and
a page redirection table having an entry for each page of a host physical address (HPA) space of an information handling system corresponding with the pages of a DPA space, each entry of the page redirection table associating the particular page of the HPA space with a page within the DPA space;
wherein the memory controller is configured to receive a first memory access request from a host processor, the memory access requests being addressed with HPAs, and to fulfill the memory access requests from a selected one of the first memory device and the second memory device based upon DPAs determined from the entries of the page redirection table associated with the HPAs; and
wherein, in response to an indication from the tiering manager that a first page of data at a first DPA in the first memory device is to be moved to the second memory device, the memory controller is further configured to move the first page of data from the first memory device to a second DPA in the second memory device, and to change the entry of the page redirection table to associate a first HPA from including the first DPA to include the second DPA.

20. The memory controller of claim 19, wherein the memory controller is a compute express link memory controller.
